(19) United States
(12) Patent Application Publication
(10) Pub. No.: US 2015/0187154 A1
(43) Pub. Date: Jul. 2, 2015

(54) Hybrid Linking-Up Lock Device

(71) Applicant: Chiao-Pen Juan, New Taipei City (TW)

(72) Inventor: Chiao-Pen Juan, New Taipei City (TW)

(21) Appl. No.: 14/146,005

(22) Filed: Jan. 2, 2014

(51) Int. Cl. G07C 9/00

(52) U.S. Cl. CPC G07C 9/00174

(57) ABSTRACT

A hybrid linking-up lock device includes a door lock device and a magnetic device. The door lock device links to an inner area of a door, which is near a middle section of a door, and by the door lock device that operates, the door is controlled for opening and closing. The magnetic device is installed at a corner of the door and links together to the door lock device. The door lock device and the magnetic device are thereby controlled by an enabling and disabling signal and an operation for opening and closing. Thus, the easy double access control is achieved.

### BACKGROUND OF THE DISCLOSURE

a) Technical Field of the Invention

This invention relates to a hybrid linking-up lock device of double safeguard for opening and closing a door by using a single signal or operation and particularly to a hybrid linking-up lock device used in a building or the equivalent.

b) Description of the Prior Art

Residential security is extremely important. Further, to guard against crime incidents emerging, there are various types of door locks improved with each passing day. In addition to mechanical keys widely used to open the door, in the related industry, electronic sensor locks, electronic combination locks, and wireless remote control locks are designed and developed for the usefulness and convenience of door locking and for the high security.

In Taiwan Patent No. 537285, of which the title is DOOR CONTROL APPARATUS AND LOCK FOR THE SAME, for example, the structure is formed with a mechanical lock, an electronic lock (e-lock), a controller module, and an unlocking slot, and at least one USB flash disk. The e-lock is electrically connected to the controller module. In the controller module, at least one unlocking code is stored. The unlocking slot is electrically connected to the controller module, and the unlocking slot is a universal serial bus (USB) slot. The USB flash drive has a code and is provided with a USB connector. The USB connector of the USB flash drive is used for insertion to the USB slot. The controller module determines whether or not the code of USB flash drive matches with at least one of the unlocking keys for enabling or disabling the e-lock.

However, although the door lock is provided with the extra e-lock for safeguard, reversely, if the USB flash drive used for unlocking the door is lost, it is afraid that someone who picks up the flash drive is malicious to easily enter the house or office of the owner of USB flash drive. Further, the handling procedure for a new USB flash drive is complicated and troublesome and the cost of making a new one is higher than that of making a new mechanical key; thus, the user cannot unlock the door in a short time to enter the house. Accordingly, it is apparent that improvement is necessarily made.

Consequently, because of the technical defects described above, to provide the user-friendly hybrid linking-up lock device of double safeguard, the applicant, based on many years of research and experience in the relevant industry has developed the present invention, which may effectively improve the defects described above.

### SUMMARY OF THE INVENTION

This invention is mainly to provide a hybrid linking-up lock device of double safeguard for opening and closing a door by using a single signal or operation.

In order to achieve the object mentioned above, the hybrid linking-up lock device according to this invention comprises a door lock device and a magnetic device. The door lock device links to an inner area of a door, which is near a middle section of a door, and by the door lock device that operates, the door is controlled for opening and closing. The magnetic device is installed at a corner of the door and links together to the door lock device. The door lock device and the magnetic device are thereby controlled by an enabling and disabling signal and an operation for opening and closing. Thus, the easy double access control is achieved.

In the hybrid linking-up lock device, the door lock device is an inductive e-lock, such as one of a fingerprint sensor lock, a palm-print sensor lock, and a RFID lock.

In the hybrid linking-up lock device, the door lock device is a non-inductive mechanical lock, such as a key-based lock.

In the hybrid linking-up lock device, the magnetic device is one of an anode lock and a cathode lock.

In the hybrid linking-up lock device, a driving device is further provided at upper and lower ends of a door shaft of the door.

In the hybrid linking-up lock device, the driving device is one of a power-driving motor, an oil pressure cylinder, and a hydraulic pressure cylinder.

In order to further know the features and technical means of this invention, refer to the detailed description below according to this invention accompanied with drawings; however, the accompanied drawings are provided for reference and illustration only and are not limited to this invention.

### BRIEF DESCRIPTION OF THE DRAWINGS

FIG. 1 is a plane view of a hybrid linking-up lock device according to this invention.

FIG. 2 is a block diagram of the hybrid linking-up lock device according to this invention.

FIG. 3 is a block diagram of the hybrid linking-up lock device in a first embodiment of this invention.

FIG. 4 is a block diagram of the hybrid linking-up lock device in a second embodiment of this invention.

FIG. 5 is a block diagram of the hybrid linking-up lock device in a third embodiment of this invention.

FIG. 6 is a block diagram of the hybrid linking-up lock device in a fourth embodiment of this invention.

FIG. 7 is a block diagram of the hybrid linking-up lock device in a fifth embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise foliar disclosed.

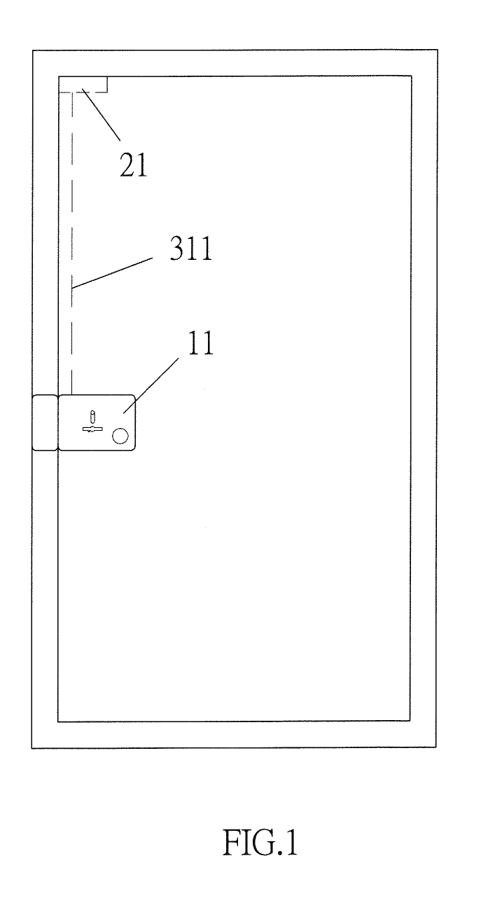

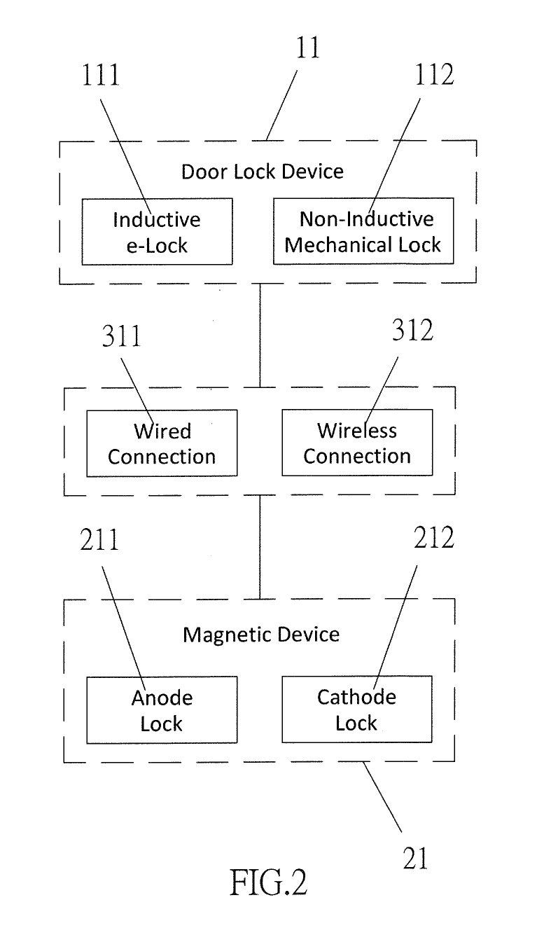

Refer to FIGS. 1 and 2. A hybrid linking-up lock device according to this invention comprises a door lock device 11 and a magnetic device 21. The door lock device 11 links to an inner area of a door, which is near a middle section of the door, and by the door lock device that operates, the door is controlled for opening and closing. The door lock device 11 is an inductive e-lock 111, such as one of a fingerprint sensor lock, a palm-print sensor lock, and a RFID lock, or a non-inductive mechanical lock 112. The magnetic device 21 is installed at a corner of the door and links together to the door lock device 11. The magnetic device 21 is one of an anode lock 211 and a cathode lock 212. The magnetic device 21 works with the door lock device 11 by means of a wire connection 311 or a wireless signal transmitter 312.

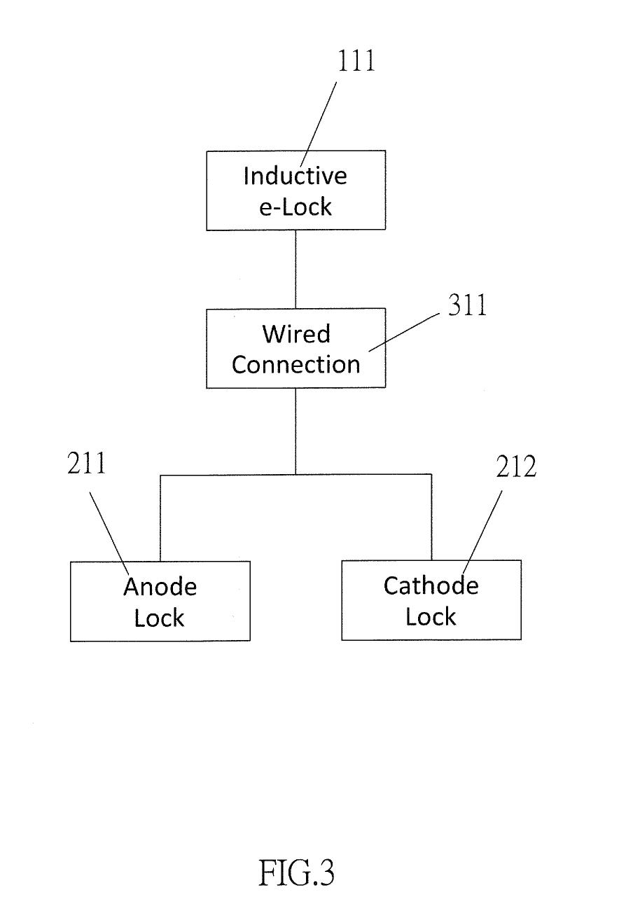

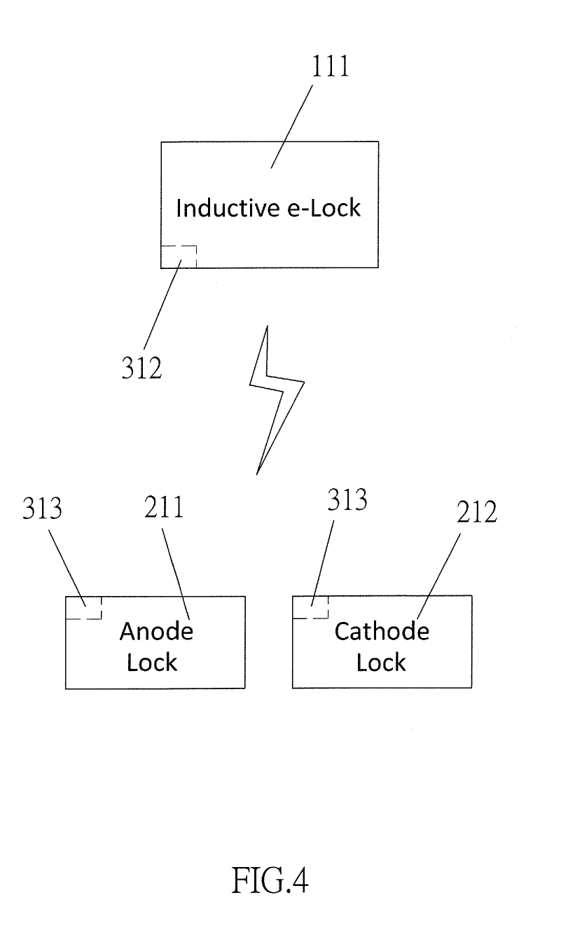

Refer to FIG. 3 as a block diagram illustrating the door lock device 11 that is, for example, an inductive e-lock 111. The inductive e-lock 111 links to and works with an anode lock 211 or a cathode lock 212 by means of a wire connection 311, and thus when detecting it, the inductive e-lock 111 drives and works with the anode lock 211 or cathode lock 212 for making the door close and open. Then, refer to FIG. 4. The inductive e-lock 111 may also work by means of wireless connection; namely, the inductive e-lock 111 is provided with a wireless signal transmitter 312 for wireless connection. The anode lock 211 and the cathode lock 212 are provided respectively with a wireless signal receiver 313 for wireless connection. Accordingly, when the inductive e-lock 111 detects an external signal, the wireless signal transmitter 312 of inductive e-lock 111 transmits an enable signal to the anode lock 211 or cathode lock 212 to drive and work with for making the door close and open.

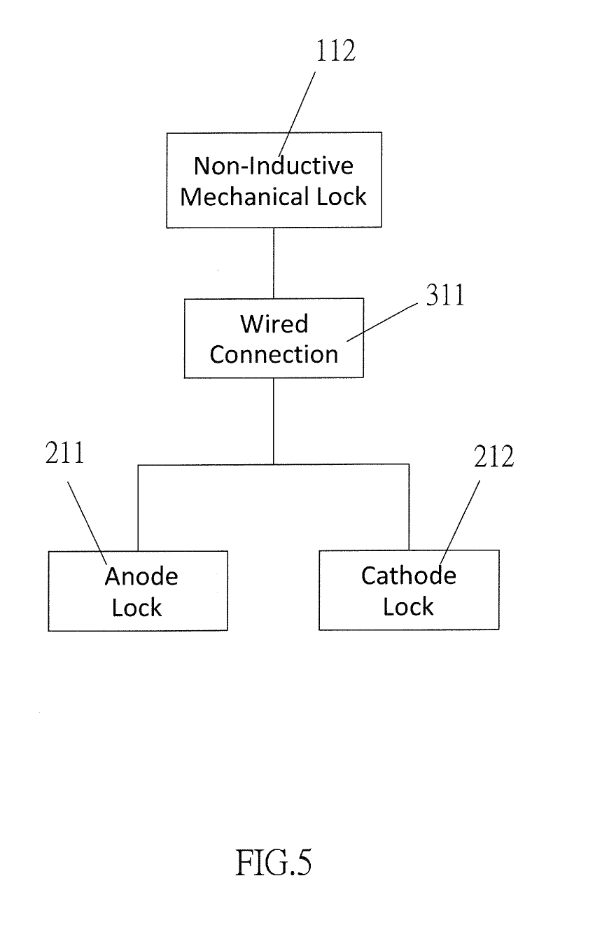

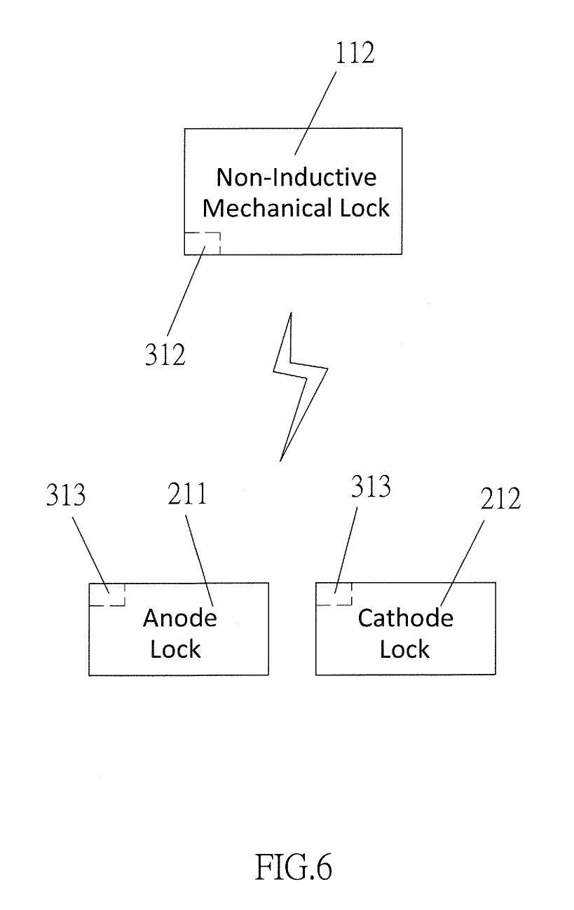

Further, refer to FIG. 5 as a block diagram illustrating the door lock device 11 that is, for example, a non-inductive mechanical lock 112. The non-inductive mechanical 112 links to and works with the anode lock 211 or cathode lock 212 by means of the wire connection 311, and thus when being driven by a key, the non-inductive mechanical lock 112 drives and works with the anode lock 211 or cathode lock 212 for making the door close and open. Then, refer to FIG. 6. The non-inductive mechanical lock 112 may also work by means of a wireless connection; that is, the non-inductive mechanical lock 112 is provided with a wireless signal transmitter 312 for wireless connection, and the anode lock 211 and the cathode lock 212 are provided respectively with a wireless signal receiver 313 for wireless connection. Accordingly, when the non-inductive mechanical lock 112 is driven by the key, the wireless signal transmitter 312 is enabled to transmit a signal to the wireless signal receiver 313. The transmitted signal may drive the anode lock 211 or cathode lock 212 for making the door open and close. The door lock device 11 and the magnetic device 21 are thereby controlled for achievement of easy operation and double control.

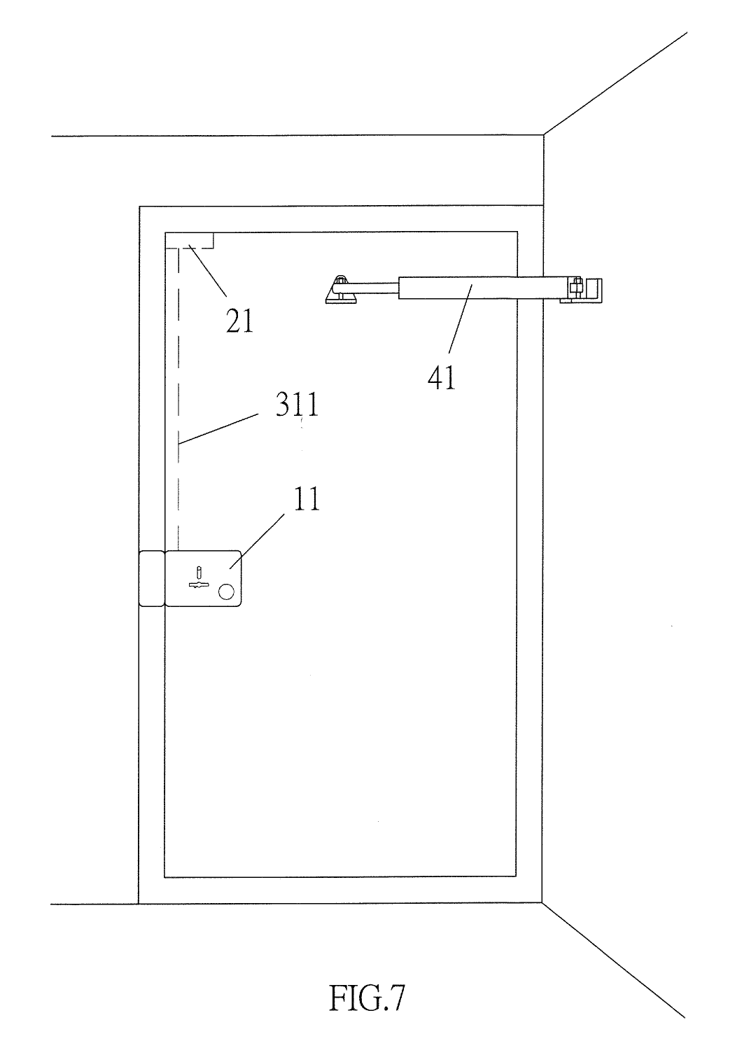

A driving device is further provided at and connected to the upper and lower ends of the shaft of door connected to the door lock device 11 and the magnetic device 21. The driving device is one of a motor-driving shaft, an oil pressure cylinder, and a hydraulic pressure cylinder. In this embodiment, the driving device is a motor-driving shaft 41, as shown in FIG. 7, making the door close automatically after the door opens for a while.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A hybrid linking-up lock device, comprising:
a door lock device, linking to an inner area of a door, which is near a middle section of a door, and operating to control the door for opening and closing; and
A magnetic device, being installed at a corner of the door and links together to the door lock device, the door lock device and the magnetic device being thereby controlled by an enabling and disabling signal and an operation for opening and closing.

2. The hybrid linking-up lock device according to claim 1, wherein the door lock device is an inductive e-lock.

3. The hybrid linking-up lock device according to claim 2, wherein the inductive e-lock is a fingerprint sensor lock.

4. The hybrid linking-up lock device according to claim 2, wherein the inductive e-lock is a palm-print sensor lock.

5. The hybrid linking-up lock device according to claim 2, wherein the inductive e-lock is a RFID lock.

6. The hybrid linking-up lock device according to claim 1, wherein the door lock device is a non-inductive mechanical lock.

7. The hybrid linking-up lock device according to claim 6, wherein the non-inductive mechanical lock is a key-based lock.

8. The hybrid linking-up lock device according to claim 1, wherein the magnetic device is wired to or wirelessly connect to the door lock device.

9. The hybrid linking-up lock device according to claim 1, wherein the magnetic device is one of an anode lock and a cathode lock.

10. The hybrid linking-up lock device according to claim 1, wherein a driving device is further provided at upper and lower ends of a shaft of the door.

11. The hybrid linking-up lock device according to claim 6, wherein the driving device is one of a motor-driving shaft, an oil pressure cylinder, and a hydraulic pressure cylinder.
